(19) United States
(12) Patent Application Publication
(10) Pub. No.: US 2002/0065682 A1
(43) Pub. Date: May 30, 2002

(54) VIRTUAL DOCTOR INTERACTIVE CYBERNET SYSTEM

(76) Inventor: DAVID M. GOLDENBERG, MENDHAM, NJ (US)

Correspondence Address: FOLEY & LARDNER, SUITE 500, 3000 K STREET NW, P O BOX 25696, WASHINGTON, DC, 200078696

(21) Appl. No.: 09/313,278

(22) Filed: May 18, 1999

(51) Int. Cl. G06F 17/60

(52) U.S. Cl. 705/2

(57) ABSTRACT

An interactive network-based health information system provides up-to-date medical information directly to a user. The information is tailored to the user's expertise. The user can issue specific follow-up questions, initiate a discussion with a professional, and establish a doctor-patient relationship. The system provides for remote monitoring and diagnosis of the patient and for remote treatment. The different levels of service can be provided and priced on an individual basis.

### BACKGROUND OF THE INVENTION

1. Field of the Invention

The present invention relates generally to the accessing of medical information and management, and more particularly to an interactive virtual doctor system using a network.

2. Description of the Related Art

Advances in medical knowledge are so rapid and extensive that it is hardly possible, with the current plethora of journals, books, Internet information and literature sources, for medical professionals, no less the lay public, to keep abreast of important new disease-related progress. Professional articles can be published in many hundreds of journals, some easily accessible and others less accessible, professional publications sometimes require a year or two from the time of submission to the date of publication. Books are even more outdated sources of current medical knowledge, since it can take three or more years from the start of a text with chapters written by various and multiple authors to actual final printing and distribution.

However, many individuals need more current information, and they often need it quickly. As an example, a patient with superficial bladder cancer that has relapsed from a standard therapy needs to secure the most up-to-date information after being told that the next step is surgery, e.g., the patient, as is common seeks out a second or third opinion. This is costly and time-consuming, especially when this selection process is not necessarily easy for an emotionally distressed patient. Patients also seek to secure information through books, lay articles, or other sources, including information provided through a multiplicity of Internet web sites concerned with health, cancer, or many related subjects. Often web sites dedicated to the specific malady do not exist. Even if web sites do exist which are dedicated to the malady, e.g., bladder cancer, the information is often general and would not necessarily be responsive to this patient's immediate needs. A call to a specialized agency, such as the American Cancer Society or the National Cancer Institute, would also result in securing both general cancer and specific bladder cancer information, but this would also not be tailored to the immediate questions and needs of this patient. Even if the patient were knowledgeable enough to read and understand the medical literature and retrieve this literature through one of the many literature search engines, the different views and often contradictory results can be uninterpretable without some guidance and assistance with regard to differentiating available, accessible, and more investigative interventions, and what their outcomes are.

Therefore, there is a need for patients to have easy access to any medical subject of interest in a convenient and focused way, while also having the ability to narrow the information needed to very specific questions, and to have the information issued through an interactive, virtual doctor interaction.

A second need is to receive a balanced second opinion on any medical problem, whereby the patient supplies, as requested, pertinent personal medical information needed to give a proper assessment.

There is also a need for a virtual doctor which can link diagnostic and treatment devices used by a patient, for example, at home, to a remote facility, which includes a processor that responds to the data gathered, to administer treatment from the remote location.

### SUMMARY OF THE INVENTION

An embodiment of the present invention is directed to providing a user with multiple levels of service to accommodate the user's specific needs. This and other features of the invention utilize a networked computer system which communicates with the user and allows the user access to one or more levels of service. Such a system would typically have a computer acting as a server receiving messages from the user and routing information and messages between the user and other computers or communications devices which interface with professionals. Communication with such a system can take place over a public data communications network, the Internet being one example of such a network. Alternatively, the server can communicate with a user over a dedicated line such as a dedicated telephone line or a dedicated channel of a broadband communications medium. Other networks are also possible and need not be hard-wired. A network may utilize, without limitation, cellular, radio, telephone, and satellite technology.

Access to the various levels of service can be determined by subscription or by the context of the user inquiry. The server can conduct communications with the user through a convenient interface, such as a graphical interface using hypertext markup language or Java or any other suitable programming language and/or environment. In such applications, a user conveniently enters information into a menu transmitted by the server to the user. The particular menu items transmitted are determined by the server based on the user's inquiry. The server can also provide the user with a direct communications path to a professional, such as one or more medical doctors and an entire team of advisors providing coordinated care and advice via the network. This virtual team can include not only individual professionals, but also automated systems incorporating artificial intelligence features. The advantage of such automated systems is their ability to apply rules and other reasoning techniques to recognize potential negative interactions or other alternatives to treatments recommended by the professionals.

As discussed further herein, the first level of service is primarily informational, allowing a user to request information at the specific level of sophistication appropriate to the user's ability to use the information. At a second level of service the user can comment on the adequacy of the information and the system can determine if referral to a professional is necessary. At a third level of service a client-professional relationship is established and a professional advises the patient concerning the information needed and other actions which should be taken. At this level, the system can also identify several professionals who should form a team to advise the patient. At a fourth level of service, the system physically interacts with the patient, using monitoring devices or treatment devices. The system communicates messages to and from the devices to monitor patient parameters and to administer management advice, including monitoring or treatment, such as with drugs or other chemicals.

Briefly, according to one aspect of the present invention, there is provided a multiple level service system including a processing device. The processing device is responsive to inquiries received over a communications medium. The processing device identifies a level of service and provides a user progressively greater degrees of interaction at respective levels of service.

Briefly, according to another aspect of the present invention, there is provided a networked system linking individuals with a server that provides practical medical, veterinary, or health care information on disease or health subjects of interest to an inquirer. The server also allows the inquirer to interact with health care professionals at several levels, from pure information gathering to medical diagnostic and therapeutic interventions by telemedicine methods.

Briefly, according to another aspect of the present invention, there is provided a networked health care service that provides a client with one or more levels of service.

Briefly, according to another aspect of the present invention, there is provided a server for an electronic inquiry-based information system, intended for use with a computer connected to the server over a network. The server includes a network connection, a user interface, a system for determining a level of service access for the user, a system for determining a level of sophistication of the user, a search processor, a system related to selecting professionals, and a communication system. The network connection is to connect to the network and to provide a communication path with the computer. The user interface is to present information over the network to a user at the home computer, and to accept an inquiry over the network from the user at the home computer. The search processor is to create search requests used to acquire information requested in the user inquiry. The system related to selecting professionals is for providing a selection of professionals to the user and for creating a team from the selection of professionals for treating a health-related issue of the user. The communication system is for directing the user inquiry to the team of professionals.

Briefly, according to one aspect of the present invention, there is provided a method of providing practical medical, veterinary, or other health care information on disease or health subjects of interest to a user. The method includes determining a desired level of service access for the user. The method further includes accepting an inquiry from the user and composing a search request based on the user inquiry. The method further includes searching a database, using the search request, in order to identify information requested in the user inquiry. The method further includes providing the search results to the user. The method further includes accepting a follow-up inquiry from the user which entails providing a higher level of service access. The method further includes allowing the user to request a consultation with a health care professional and, if desired by the user, providing the user with a list of possible health care professionals.

Briefly, according to one aspect of the present invention, there is provided a health care system for delivering health care to a patient. The system includes a server, a monitoring device, and a treatment device. The server is communicatively coupled to a network and is for receiving and transmitting signals. The monitoring device is communicatively coupled to the network and is adapted to be connected to the patient. The monitoring device is adapted to monitor the patient and to transmit patient information to the server over the network. The treatment device is communicatively coupled to the network and is adapted to be connected to the patient. The treatment device receives a treatment signal from the server over the network and is adapted to administer a treatment to the patient based on the treatment signal received.

### BRIEF DESCRIPTION OF THE DRAWINGS

An embodiment of the present invention is described herein as illustrated by the following figures:

FIG. 1 illustrates a system according to the invention using a private communications network;

FIG. 2 illustrates a system according to the invention using a public communications network;

FIG. 3 is a flow diagram illustrating initial access to a system according to the invention;

FIG. 4 is a flow diagram illustrating a first level of access of a system according to the invention;

FIG. 5 is a flow diagram illustrating a second level of system access according to the invention;

FIG. 6 is a flow diagram illustrating a third level of system access according to the invention;

FIG. 7 is a flow diagram illustrating a fourth level of access to a system according to the invention; and

FIG. 8 illustrates a system according to the invention for remote monitoring and/or treatment.

### DETAILED DESCRIPTION OF SPECIFIC EMBODIMENTS

A system according to the invention can be implemented in multiple levels on a network. One convenient way of implementing such a system is to provide a site on the world wide web of the Internet which can be accessed by the users. Users can select levels of service from this virtual doctor web site. At the highest level of service according to the invention, advances in telemedicine are incorporated in this virtual doctor web site by linking diagnostic systems available in the home or in local medical facilities to the central web site in order to transmit physical and chemical findings and data for analysis by the advising health professionals. These could involve, for example, cardiac and circulatory functions, blood tests, urinalysis, sputum tests, etc., which can be used to monitor the patient. It is also envisioned that this can be an interactive treatment system, whereby the central monitor can send signals to a monitor in the patient that controls the discharge of energy impulses, chemicals, and drugs that regulate the patient's body functions.

These descriptions are intended to be examples of the many applications possible with this interactive system, and not restrictive. An individual knowledgeable in the art of medicine, in the technology of telemedicine, and in the functions of networked systems and cyberspace will be able to make many more applications and uses of the system described.

A basic element of the virtual doctor system according to the invention is an agent, such as a processor or other computing device. The agent allows a home or remote system, linked via the Internet or another communications network, to identify and access one or more information sources, such as computers or databases, or other systems. An information source may be accessible, for example, through one or more web sites, and the information source provides access to information relating to the subject matter identified by a patient or client. The system according to the invention provides real time interaction between a user and a service provider. The server has several components, each representing a different level of service. Any one of the components can be acquired and they can be used individually or in concert with other components. In addition, at each service level, the system can provide sublevels of information to accommodate the user's needs.

1. Level 1:

An information retrieval system that allows the latest available knowledge or article on a specific medical subject to be forwarded to the client, and the level of complexity of this information is requested in advance by the client. This level could be in several categories, for example, such as very basic (little medical knowledge), more sophisticated (more medical knowledge, but still for the layman), and advanced medical knowledge (for the health care professional). This information need not be individualized for the client, but is intended to respond to the client's general need for information on the disease or health care problem, and is intended to answer some basic questions by providing general knowledge about the problem.

2. Level 2:

The system permits the client to comment on the adequacy of the information/literature provided and to request further follow-up with more specific information. This follow-up is then implemented by the server's computer programs, providing the additional service or information requested or, if unavailable, a link to a health care professional who is capable of reviewing the problem and need for further action. If the professional can identify a suitable response, then this is implemented. If not, the problem is referred, after approval by the client, to a medical expert in the subject, thus engendering a higher level of service. The latter service then involves a patient (client)-doctor interaction, requiring the patient to disclose, if needed, personal medical information under an agreed policy and relationship between patient and professional provider.

3. Level 3:

Once the level of a client-professional relationship is established, the health care professional advises the patient regarding the information needed, and what further actions may be necessary, including, if desired, names of other sources of professional assistance in the client's region or domicile. The system is particularly useful because the selection of the appropriate health care specialist is made from a list of this service's participants worldwide, who are renowned experts in the specific subject of interest. The list of experts in this system can, but need not, be published on the system. Publication would allow the client to make choices, based upon the information provided, according, for example, to the country or region where the health care professional practices, and other considerations.

In the event, for example, that the patient has an incurable malady, or one that is difficult to treat, the system can provide a list of appropriate research studies for which the patient may be eligible. These may be local, regional, national, or international, as selected by the patient, preferably in consultation with the health care advisor.

4. Level 4:

At the level of using the virtual doctor to monitor and control the patient's body functions, the system involves home or local telemedicine devices that provide information on different body systems and functions to the central or subsidiary servers for analysis or intervention. This could also involve an online receiving or discharging system, whereby the patient has an implanted sensor or chip that can monitor or control body functions, including the dispensation of signals, chemicals, or drugs (the latter by implanted reservoirs of controlled-release chemical or drugs) into the patient by remote-controlled computer-assisted integration systems.

These basic components are examples that can be modified, extended, or permuted to accomplish similar objectives, which would be within the skill level of one ordinarily knowledgeable in this art, and are not intended to be restrictive in scope and function. Not all of the components or levels need to be operational at the same time, or used by the client, but the combination of these different functions increases the novelty and user value of the system.

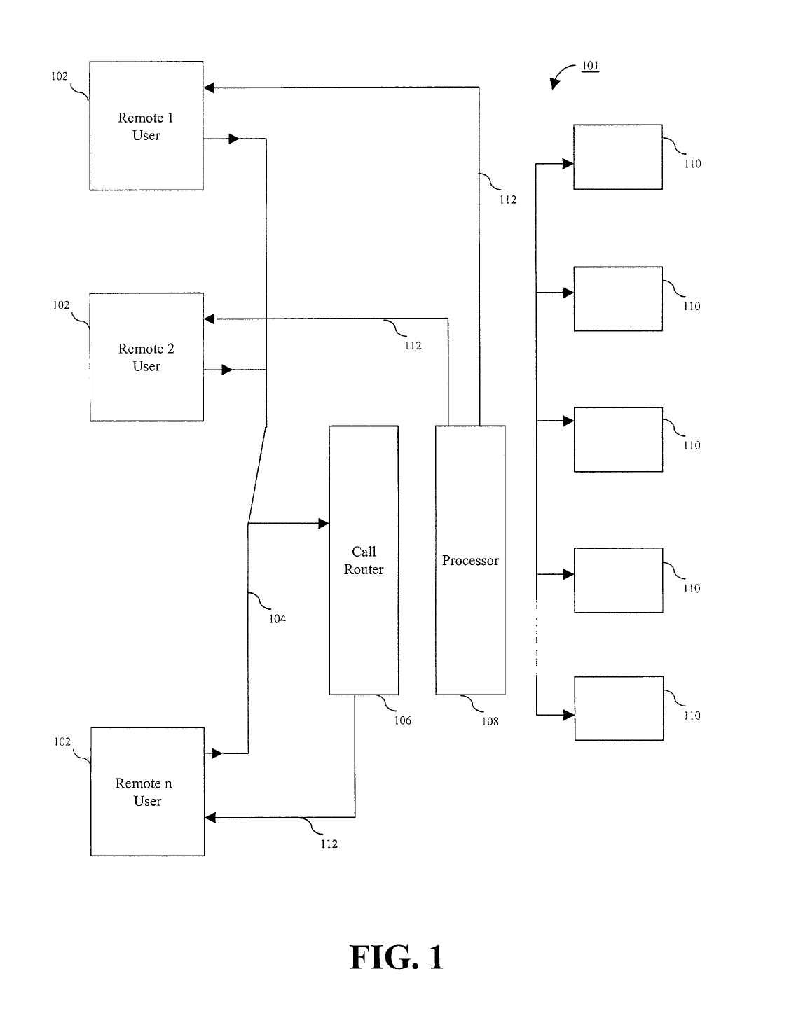

FIG. 1 illustrates a system 101 according to the invention using dedicated line access. Remote users 102 access the system through a dedicated phone line 104, for example by calling an 800 number. A call router 106 routes the individual calls to processor 108. Processor 108 receives and communicates with databases or other devices 110. Upon receipt of an inquiry, processor 108 matches the inquiry to the remote user, satisfies the inquiry and advises the call router that a response is available. Call router 106 then routes the response to the individual user over lines 112. Where sensor data are transmitted between the user and the processor, for example from telemedicine devices, the processor 108 may be programmed to decode the data for further processing and to encode responses to be transmitted to the remote user location. Such encoding could be for data compression or for security purposes. The dedicated communication lines in this implementation could be individual telephone lines or dedicated channels of high bandwidth links, such as fiber optic links.

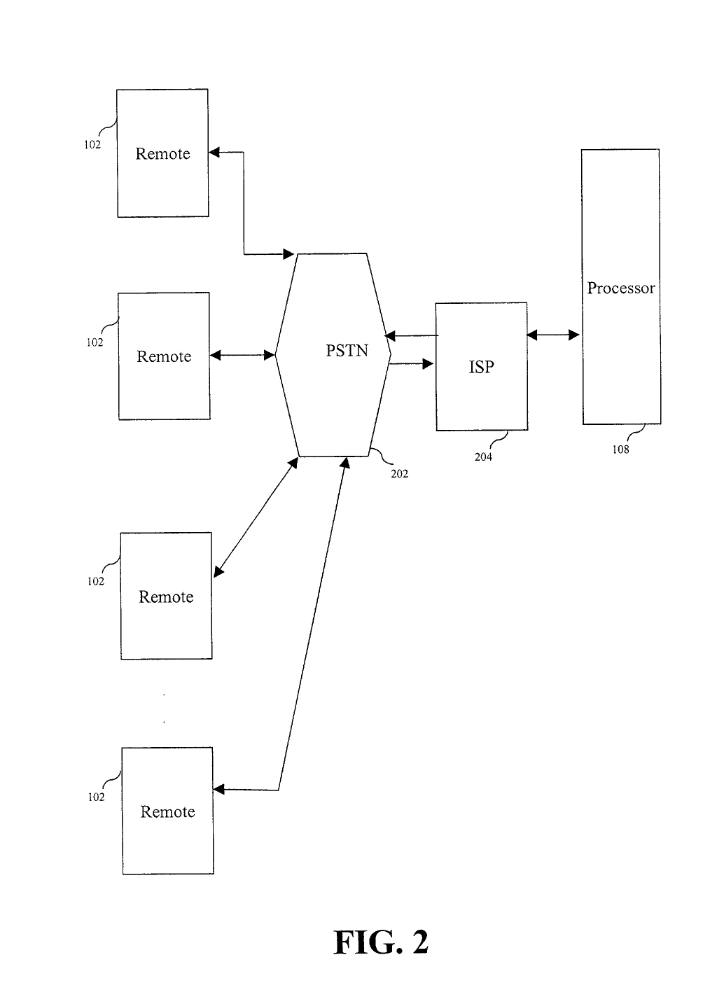

FIG. 2 illustrates an alternative embodiment suited to advanced communication networks and to communications through a public switch telephone network or other public network. In this case, users 102 communicate through a public switch telephone network 202 to a service provider such as an Internet service provider 204. The Internet service provider then routes a user's inquiry to the processor 108. Communications using this type of network can be conducted using standard network protocols, such as TCP/IP. Those of ordinary skill will recognize that other networks and other network protocols could also be used.

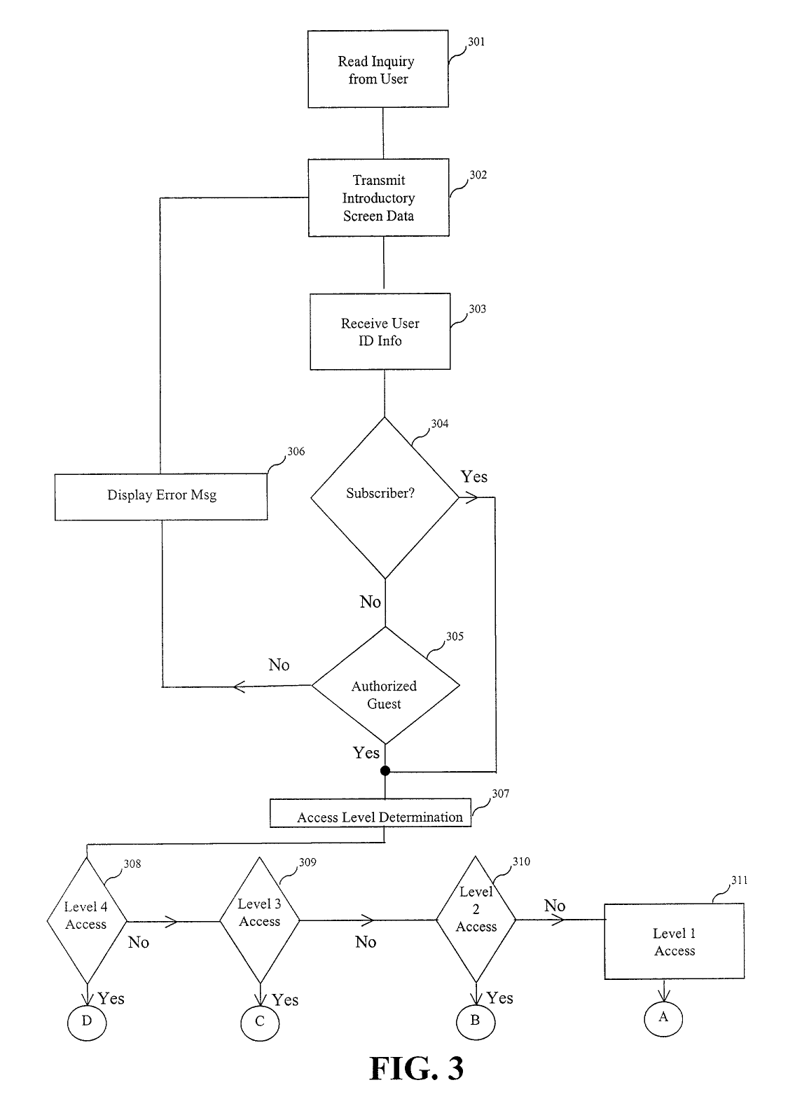

FIG. 3 illustrates one possible introductory process responsive to user access. When the user accesses the system in step 301 the system reads an inquiry from the user and recognizes it as an inquiry. The inquiry in step 301 could merely be an indication that information is desired, such as clicking in a portion of a web page, or it may, as an example, be a question formulated in a text entry field. The processor responds at step 302 by transmitting information to identify the user and the appropriate level of system access. One way of transmitting the data is to transmit a menu screen which requires the user to fill in certain fields with a user ID and password, as would be known to those of ordinary skill. In step 303 the system receives the user identification information and in step 304 determines whether the user is an authorized subscriber. Step 304 could be accomplished by comparing the user ID and password to identification numbers and passwords stored in the database of authorized users. If the user is an authorized subscriber the system can then begin to secure for the user the desired level of access.

The system can also accommodate non-subscribers who are authorized guests. In step 305, the system determines if a non-subscriber user is an authorized guest. A variety of methods can be used to allow users to become authorized guests. As examples, a promotion could allow guests to have access for a specific period of time, or a guest might register in a guest database which will allow access to the system for a set time period, such as one month. The determination in step 305 can be made by comparing the authorized guest database to the information provided by the user at steps 302 and 303. If the user is an authorized guest access will be permitted. However, if the user is not an authorized guest, as determined at step 305, an error message is displayed at step 306.

Assuming that the user is a subscriber or an authorized guest, control passes to step 307 which is access level determination. Step 307 can determine the authorized access level for a user in several ways. In one method, users subscribe to various access levels. The information is stored in a database and in the same manner as determining whether a user is a subscriber, the user's authorized level of access is determined. Alternatively, the system could determine user access level from a context of the user inquiry. For example, after having determined that a user is authorized to access the system, the processor could transmit to the user a screen requesting the user to provide its inquiry. Alternatively, if the inquiry was formulated in step 301, the processor could access that previously entered data. The processor could then read the inquiry and determine the appropriate level of access required to respond to the inquiry. For example, a simple question such as “What is leukemia?” would generate a relatively simple level 1 response. In this case, the processor would simply access a database of medical definitions and provide the appropriate response to the user. In contrast, a more sophisticated question such as one that describes symptoms in detail and uses extensive technical language would be interpreted by the processor as coming from a sophisticated user and could generate a more sophisticated response. Other types of inquiries could result in the processor recognizing that a professional consultation is needed for an adequate response and would advance immediately to level 2 or level 3 processing. If the inquiry includes data from a remote telemedicine device, the processor would move directly to level 4 processing. This type of context based access allows the processor to evaluate the inquiry and to determine the appropriate level of service. It should be noted that the different levels of service may be priced differently. Therefore, before actually granting access to the service, the system could also be programmed to verify that a user's account is current or to advise the user that the level of service required will incur a certain cost and request the user's credit card number or other payment method.

Steps 308 through 311 illustrate the progressive nature of the service levels accessible by the system. Thus, if level 4 access is not required it is determined whether level 3 access is required or level 2 access is required until the basic level 1 access is selected. The hierarchy embodied in FIG. 3 is an example only, and other hierarchies or decision processes are clearly within the scope of the invention. By way of examples only, the decision progression of steps 308-311 may be reversed, or each access level may be entered directly from step 307.

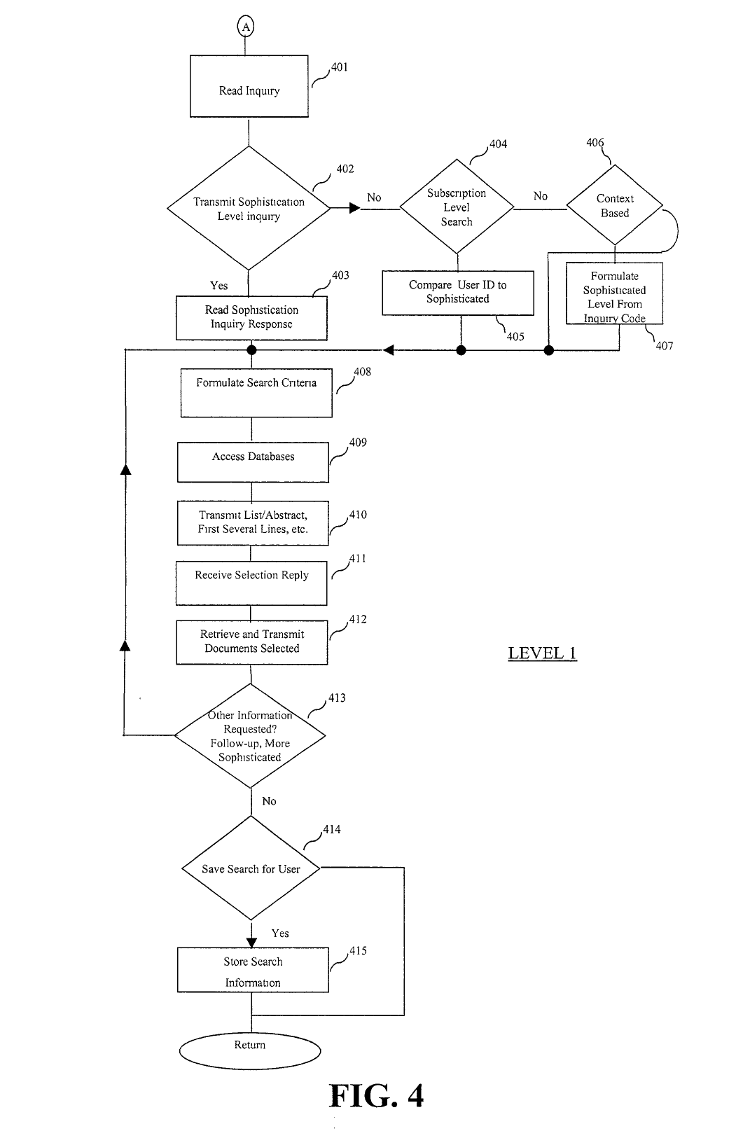

FIGS. 4 through 7 illustrate the activities which take place at the various service access levels. FIG. 4 illustrates activities which take place at the first level of service (level 1) which is primarily a literature access service. A feature of the system according to the invention is that the literature access can be tailored to the sophistication level of the user. For example, researchers, medical students, doctors, and other professionals or semi-professionals may require more sophisticated literature than those without such specialized skills. At step 401, an inquiry is read, as described with respect to steps 301 and/or 307, for example. At step 402, the system according to the invention allows the processor to transmit an inquiry to the user asking for the desired level of sophistication. The system may transmit this information in any suitable form, for example, by requesting information about the user's level of education or by using a sliding scale reflecting the sophistication of the information to be transmitted. The system can also employ a sliding scale, e.g., 1-10 with 1 representing very basic information, 10 representing very sophisticated information with intermediate levels in between. If at step 402 the system is programmed to transmit such an inquiry, then the response is received at step 403.

Alternatively, at step 402 the system could be programmed not to transmit a sophistication level inquiry but instead, at step 404, to determine the sophistication level of the information to be provided at level 1 according to a subscription level search. If so, at step 405 the user ID and password are compared to a database to determine the appropriate level of sophistication to respond to the inquiry. Alternatively, at step 406 the system could determine the level of sophistication of the information it provides based on a contractual arrangement. If not, the system could use the context based techniques previously discussed. In any case, once the level of sophistication for the literature search is determined, at step 408 the processor determines search criteria, for example using known techniques employed by various search engines. Thus, the processor can have any number of search engines embedded therein. At step 409 the processor accesses the relevant databases and at step 410 establishes a list of documents responsive to the request. At step 410 the processor can then transmit that list to the user. The list can be transmitted to the user in the form of titles, titles and abstracts, the first several lines of the documents, or any other format which is consistent with the user's ability to understand generally what information the document contains.

The user will then respond and select which documents should be retrieved at step 411. At step 412 the system then retrieves the documents and transmits them to the user. At step 413 the user has the option of requesting additional information. The user may request more sophisticated information if he determines that the information provided in response to the previous inquiry was insufficient. At this point step 408 is repeated and new search criteria are formed by the processor. The search process then repeats and additional documents are identified. When the entire process is completed at step 413, the user may have the option of saving the search results as shown at step 414. If that option is selected at step 415 the search is stored in a suitable form. For example, the list of documents selected by the user might be stored and accessible again to the user for a fixed or indefinite period of time, depending on the subscription.

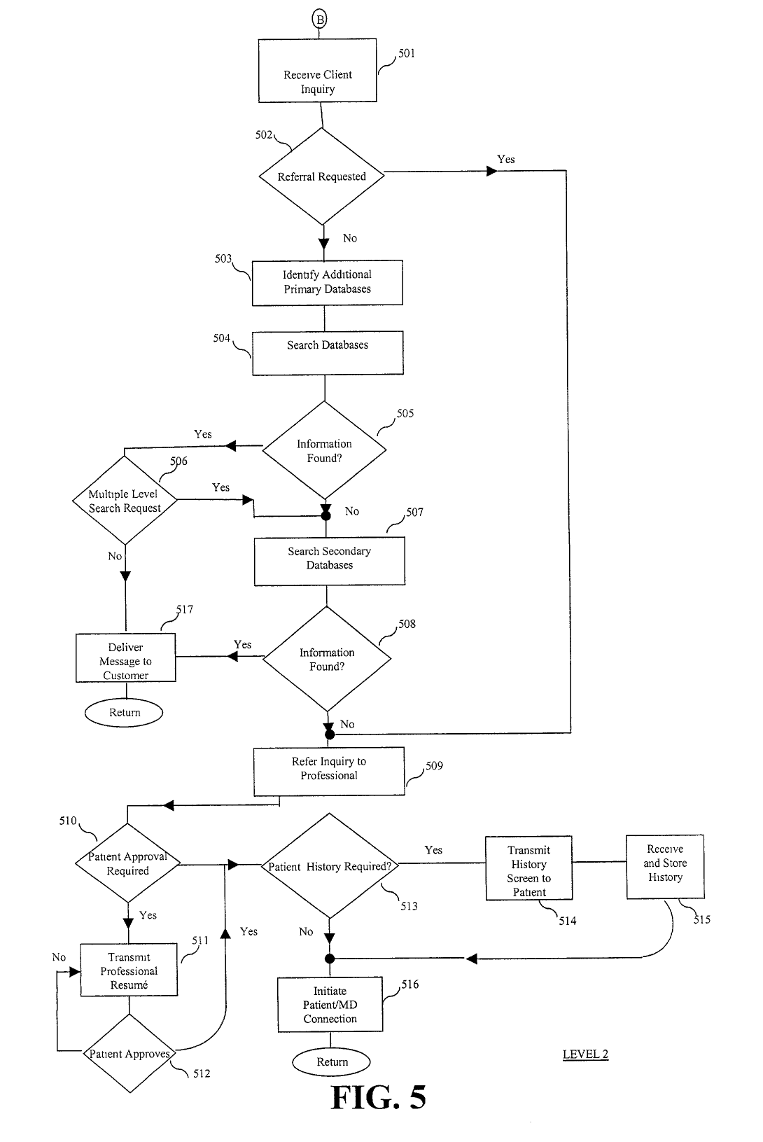

FIG. 5 illustrates processing at a second level of service (level 2). In this case at step 501 the client inquiry is received. At step 502 the processor immediately determines whether the client has requested a referral to a professional. If so, processing is advanced as shown in FIG. 5 to step 509. If not, processing proceeds at step 503. As previously discussed, at level 2 a user who has accessed information at level 1 may now be seeking additional information or commenting on the information received at level 1. Thus, the inquiry at step 501 is typically more sophisticated than that in level 1 at step 401. At step 503 therefore, the processor may be required to identify additional databases for primary searching. At step 504 that search will be conducted in accordance with search criteria. The primary database referred to in this context includes databases normally accessible by the system. If at step 505 information has been found, the system can then determine if a multiple level search request has been made by the user at step 506. If information is not found at step 505 or if the user has made a multiple level search request as determined at step 506, then at step 507 the processor can use the same search criteria to search secondary databases. In this context, secondary databases are databases which are not normally searched by the system and which could require additional fees. Such secondary databases could be accessed by the processor through a contractual arrangement with other service providers. If other information is found at step 508 or if no multiple level search request was made as determined at step 506, then at step 517 a message is delivered to the customer identifying the additional literature.

If no information was found at step 508 or if a referral was requested at step 502, then a referral inquiry to a professional is made at step 509. Since the doctor patient relationship is a special one, at step 510 the system determines whether patient approval is required before referring the inquiry to a specific professional. The referral made at step 509 is made based on the particulars of the patient inquiry. For example, a request for information relating to symptoms of diabetes would be referred to professionals with expertise in that particular field rather than to neurosurgeons. Such referrals can be made using the context based analysis techniques previously discussed herein, including referrals based on key words and reverse reasoning or other artificial intelligence techniques implemented in the processor. Assuming that patient approval is required at step 510, at step 511 the resumes of one or more selected professionals are transmitted to the patient. The professionals selected may be arrived at based on their expertise or their geographic proximity to the patient. The patient can then review the professional's resume at step 511 and approve one or more professionals at step 512. If the patient has approved a professional at step 512 or if at step 510 it is determined that patient approval is not required, at step 513 the system determines whether additional patient history information must be gathered in order to adequately answer the inquiry. If so, at step 514 a patient history screen is transmitted to the patient or user. The information is received at step 515 and at step 516 the patient-doctor contact is initiated. It should be noted that the system can be programmed to allow the doctor or other professional to accept or decline the assignment. Some professionals may feel that their expertise is not appropriate to the inquiry or that the professional's workload would prevent providing adequate service. In such cases the system would then move on to the next appropriate professional.

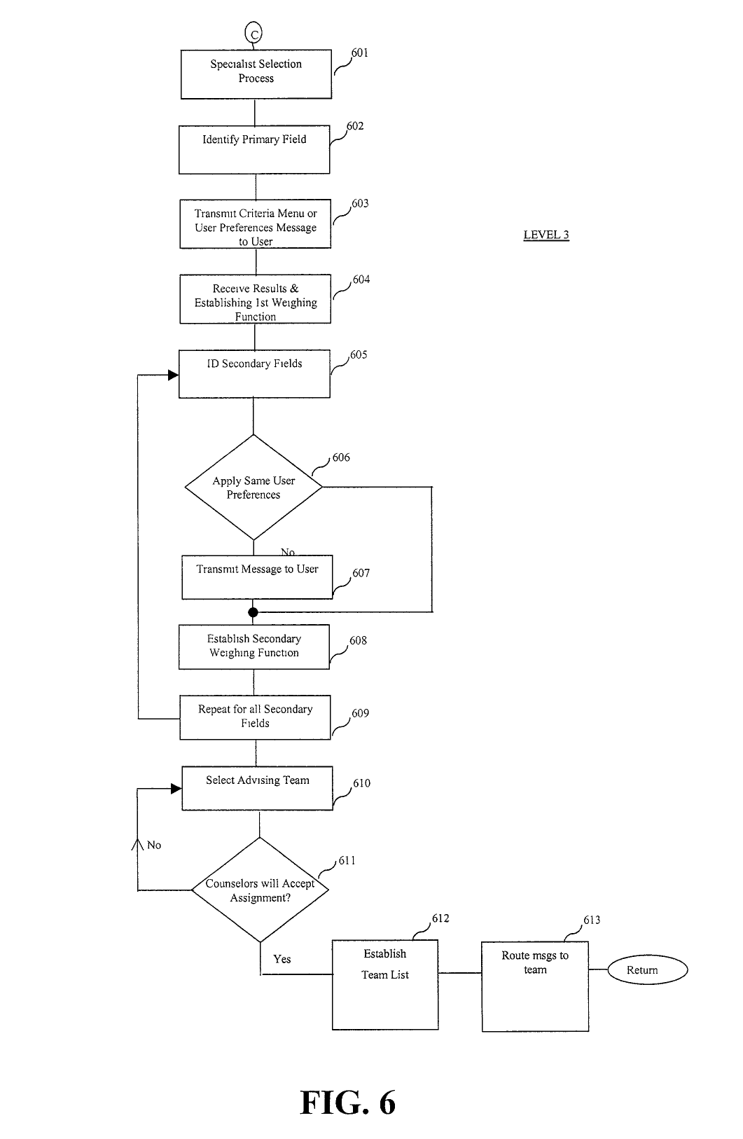

FIG. 6 illustrates a third level of service (level 3). As previously discussed herein, level 3 service may require the assistance of one or more specialists. Rather than providing only one professional to guide the user through literature searches and other inquiries, level 3 service contemplates a more complete level of service to the user. For example, level 3 service could provide the user with a team of professionals or specialists who communicate directly with the user about treatment options, risks, side affects, and other matters. Thus, level 3 service tends to focus on the specialist.

At step 601 the processor conducts a search in accordance with criteria established by the user and possibly a professional identified in level 2 service. Based on the information provided, the processor establishes a weighting function and criteria to identify appropriate specialists. The processor accesses databases of specialists and compares the qualifications of the specialists in the database with the requirements established by the patient and doctor inquiries at levels 1 and 2. The database can be organized in any form suitable for such searches. For example, the database can be organized by specialty, by specialist, by geographic region, board certification, or on some other appropriate basis. Using either criteria specifically identified by the patient and doctor, or criteria appropriate to the context of the inquiry, the processor will identify a primary field at step 602 and transmit a criteria menu at step 603 to the user. The criteria may include such things as geographic area, hospital affiliation, acceptance of various insurance payment plans, or other criteria. The criteria menu may allow the user to specify the level of importance of each of the criteria. Based on this information, at step 604 the processor will establish a weighing function and identify a list of candidate specialists.

Because many medical issues require input from specialists in various fields, the processor will then determine from the criteria, and the information provided by the user and the doctor in level 2, whether secondary specialists are necessary and in which fields secondary specialists should be consulted. At step 605, the secondary fields are identified and at step 606 the processor can inquire if the user desires to establish the same preferences for selection of specialists in the secondary or related fields. If not, a message is transmitted to the user to adjust the selection criteria in the secondary fields at steps 607. At step 608 the secondary weighing function is established and the process is repeated at step 609 until all of the secondary fields are complete. At step 610 the advising team is selected and at step 611 the counselors determine whether or not they can accept the assignment. Once the counselors have accepted the assignment at step 612 the team list is established. At step 613 messages are routed to the team members concerning the inquiry to establish treatment options or other steps. The team members may select which messages they should be copied on, as their specialty might only be relevant to certain questions.

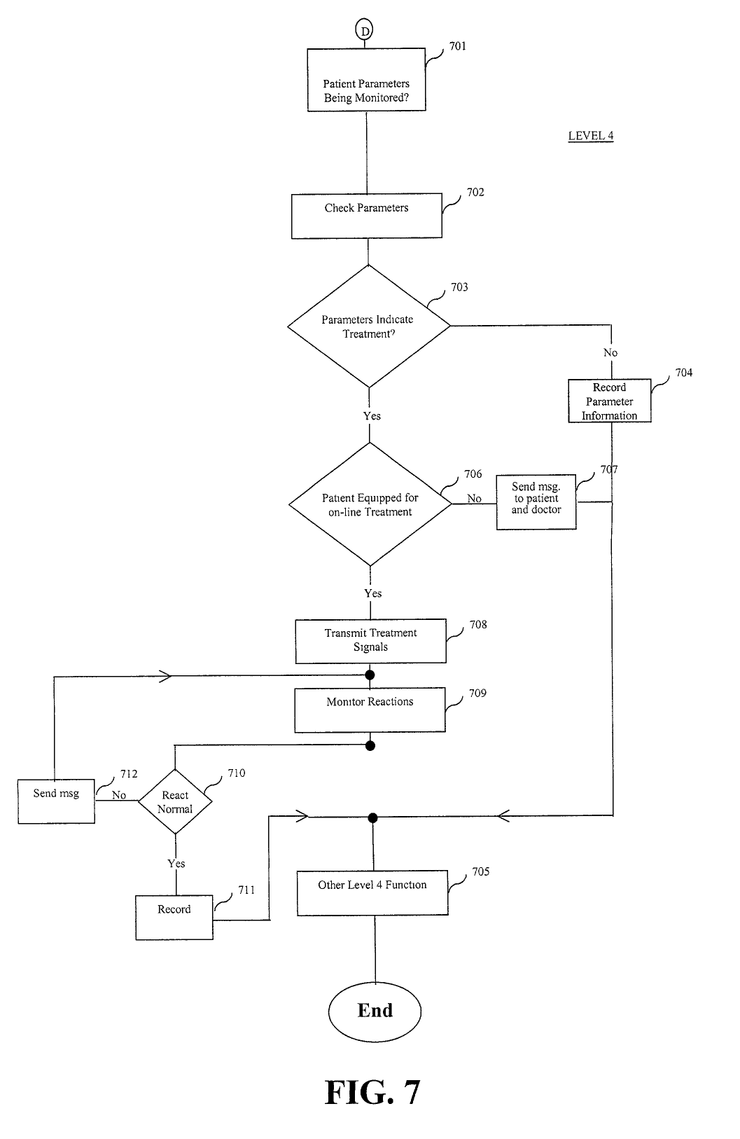

FIG. 7 illustrates processing at the most sophisticated level of the virtual doctor system (level 4). Level 4 processing is designed to implement sophisticated telemedicine techniques which would allow a user to be treated periodically or continuously at a remote location from the processor or professionals. Level 4 processing could also be used as a means for transmitting information between treatment centers. In particular, high bandwidth connections may be useful for transmitting image data to be used in diagnostic processes. In addition to the ability to display the image data, processors using artificial intelligence techniques could be used to determine or suggest the importance of the information in the image displays. As a further example, remote professionals could perform or guide remote surgery using the image data and either a digitally controlled operating instrument or under the implementation of local surgeons.

In a typical application of level 4 processing, at step 701 patient parameters which are being monitored are identified. The parameters could be included in a list and updated either periodically, at the same time, or at different times depending on the physical parameters being monitored and tested. At step 702 the processor will transmit a message to monitor the specific parameters. Depending on the equipment being used, the processor may be required to format the message into data that can be understood and processed by the particular monitoring device. When step 702 indicates that parameters have been checked, at step 703 the parameters are tested to indicate whether the patient requires treatment. If the patient does not require treatment, then at step 704 the information on the parameters is simply recorded and any other level 4 functions which are needed are performed at step 705. If, however, the parameters indicate that the patient does need treatment, then at step 706 it is determined whether the patient is equipped for online treatment. This can be determined either by a database listing or by sending a test message to determine whether the equipment is present at the remote location. The test message has the advantage of not only determining whether the equipment is present, but whether it is connected to the patient and is operational. If the patient is not equipped for online treatment either because the patient does not have the equipment or because the equipment is not operating, at step 707 a message is sent to the treating physicians and to the patient. Control then passes to step 705 which performs other level 4 functions and then terminates the session.

If at step 706 it is determined that the patient is equipped for online treatment, then at step 708 information is transmitted in a format that can be recognized by the treatment equipment to apply the treatment to the patient. For example, the processor could command the treatment device to inject the patient with drugs or other chemicals. At step 709 the patient's reactions are monitored. If at step 710 the processor determines that the patient's reactions are normal, then at step 711 the parameters are recorded and other level 4 functions can then be performed. On the other hand, if at step 710 the processor determines that the patient's reactions are out of the normal range, then a message is sent at step 712 to the patient and to the health care professional and monitoring continues at step 709. The remote treatment may also be performed in increments, with monitoring between successive treatment steps. An incremental approach thus allows further treatment after an abnormal reaction.

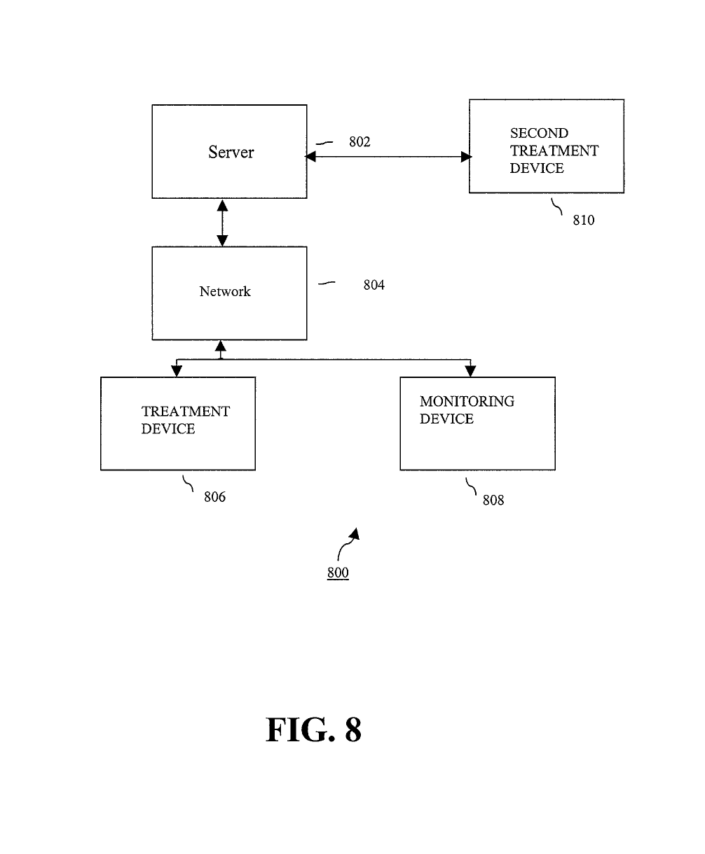

FIG. 8 illustrates at a high level a system 800 for remote monitoring and/or treatment of a patient. The system 800 includes a server 802 which is connected to a network 804. The system 800 also includes a treatment device 806 and a monitoring device 808 which are each connected to the network 804. In certain embodiments, the treatment device 806 and the monitoring device 808 may be connected to each other.

The network 804 connects the treatment device 806 and the monitoring device 808 to the server 802. The links can be set up and torn down quickly or left in place. Further, the network 804 can utilize different mediums. The network 804 may use the Internet for links with the monitoring device 808 if those links need not be maintained with high reliability, and the network 804 may also encompass more reliable dedicated lines (land, satellite, or otherwise) for links with the treatment device 806.

The treatment device 806 and the monitoring device 808 are adapted to be connected to the patient. In this way, patient information, such as blood test results, vital signs, images of the patient, etc., may be monitored by the monitoring device 808 and transmitted over the network 804 to the server 802. Further, treatments, such as performing a blood test, taking an image of the patient, delivering a drug into the patient, etc., may be administered to the patient by the treatment device 806. The treatment device 806 may be internal or external to the patient's body. It is clear that a treatment device may include, without limitation, both therapeutic and diagnostic equipment and that a treatment device can perform both therapeutic and diagnostic procedures. Further, a treatment signal may then include a signal from/to either a diagnostic or a therapeutic device. Additionally, a monitoring device may perform a variety of functions that are considered to be diagnostic.

The system 800 can also have a second treatment device 810. The second treatment device 810 can be connected to the server 802 and can communicate with either or both of the treatment device 806 and the monitoring device 808. In one embodiment, the second treatment device 810 receives patient information from the monitoring device 808 and sends a treatment signal to the treatment device 806. In such an embodiment, the treatment signal may effectively control the treatment device 806, but need not necessarily do so.

The interactive level of the system may also provide image data. The image data allows remote observation of a patient's condition, preferably both internal and external. The image data may include, for example, medical imaging data (such as from nuclear, computed tomography, ultrasound, X-ray, and other imaging cameras and systems at a medical facility) and patient-viewing data which thereby allows the patient to be viewed by the doctor at a remote location. A patient-viewing camera may be, for example, a still-motion camera or a video camera. A patient-viewing camera may be necessary, for example, for examination of certain physical signs (e.g., neurological status, mental state and functions, dermatological signs, etc.). The system can also provide two-way and multiple-party video conferencing services, that allows video conferencing by two or more parties. Image data can thus be used for a variety of functions, including without limitation, monitoring, diagnostic, and therapeutic/treatment. Further, the imaging equipment can be considered to be a monitoring device, a diagnostic device, and a therapeutic or treatment device, depending upon the application.

There are many ways in which a practitioner may control the treatment of a patient. A monitoring device or monitoring equipment may communicate the patient's body functions or chemistry to a central monitoring system. A monitoring device can also transmit health-related information about a user over the network to the server for use by a team of professionals in treating the health-related issue of the patient. The information can be used for diagnostic and therapeutic purposes In the latter case, a treatment signal, i.e., a telemedicine signal, can be transmitted over the network to a treatment device or treatment equipment connected to the patient. A treatment device may be separate from or integrated with a monitoring device. The treatment signal can control the device or equipment which is connected to the patient. The device may effect a treatment in the patient. A treatment can include, without limitation, effecting a change in body function or chemistry, such as by administering a drug or impulse, and it can include performing a test of the body, such as a blood test. The device may be remotely-controlled or the practitioner can transmit control information to the patient, or another individual, who would then have to control the equipment. The device may deliver a treatment using myriad methods. For example, it may stimulate the patient with an electrical or other impulse, or it may release a chemical or drug. The chemical or drug can be contained in a reservoir which is implanted in the body or which is external to the body, and the reservoir may also be timed-release or controlled-release. In one embodiment, the release is controlled by an implanted computerized chip linked into the communication system. The link into the communication system need not be hard-wired. For example, another piece of equipment may receive a treatment signal over the network and then send a radio frequency signal to a receiver which is implanted in a patient who is sleeping nearby.

The treatment device may also perform more complicated functions. It may receive body function signals from the patient, analyze these signals, and then return a signal to the patient that effects the treatment or test. The treatment device may also perform monitoring functions and transmit any or all of this information to a practitioner over the network.

A treatment device may also be located remotely from the patient. In one embodiment, a remote treatment device receives patient information, such as the results of a blood test or information from an examination, and sends a treatment signal over the network to a local treatment device which is connected to the patient. In this way, the remote device can receive monitored patient data and generate appropriate treatment signals to control, for example, a chip implanted in the patient which releases a chemical.

### EXAMPLE 1

### Level 1 Service to a Recently-diagnosed Bladder Cancer Patient

Patient Charles has experienced blood in his urine over the past two months, and seeks medical assistance. His doctor confirms that there is blood in his urine, and recommends a cystoscopy by a urologist, who finds evidence of a malignant-appearing lesion. A biopsy is taken, which reveals superficial urothelial carcinoma. The urologist recommends a course of BCG immunotherapy into the bladder. He is told that this has a generally good response rate, but the tumor can recur and require additional therapy, possibly including, at some time, surgical resection of the bladder if spreading to the bladder muscle occurs. Patient Charles knows little about this problem, is distraught, and needs further advice. He does not know if he should go to some well-known cancer center in his city, call the American Cancer Society, or talk to other family doctors he knows. He decides to call the American Cancer Society and receives a general pamphlet on the incidence, mortality, and prognosis, including different management methods, of bladder carcinoma. This gives him more concern, and he therefore links to the virtual doctor web site of this invention, where he requests, from Level 1, information on the management, side effects, and outcome of superficial bladder cancer, requesting information for the level of relatively uninformed lay patients. He receives a recently-updated summary of the management of superficial bladder carcinoma, tailored to his geographic domicile, because there are some differences in medical practice in different regions of the world. The summary includes BCG immunotherapy, the results achieved, alternatives to intravesicular chemotherapy, and a listing of some institutions and doctors who practice these methods in his geographic region.

### EXAMPLE 2

### Level 2 Service to Recently Treated Bladder Cancer Patient

Patient Charles went through a course of therapy with BCG, and is now told by his urologist that the tumor has recurred again, requiring some surgical intervention and removal of urothelial mucosa in the region of the neck of the bladder, and possibly some irradiation to this region. He is told that there could be post-therapy side effects, including adhesions, urination difficulties, pain, incontinence, etc. The patient's first course of therapy evidently was not as successful as intended and now he does not know what to do. He then contacts the virtual doctor web site, to which he has registered, and requests a second level of service, specifically asking for options in cases such as his. The service provides a synopsis of the medical literature on treatment of recurrent and locally invasive, but still superficial, urothelial carcinoma. The patient reads this, but becomes even more fearful that he might not choose the best of the different approaches described. He then elects to subscribe to a Level 3 consultation service.

### EXAMPLE 3

### Level 3 Medical Consultation Service

After registering at this level, the patient informs the service of his particular problem, and asks for a urological specialist who is an expert in the management of recurrent superficial urothelial carcinoma, and who is familiar with medical practices in the New York City area. The service provides two names of urologists participating in this cyberspace service who are experienced in the treatment of bladder cancer, and who practice in the New York area. Dr. Y of Mount Sinai Medical Center is chosen by the patient, and he registers his particular question with the doctor through the service, using the e-mail contact service provided at Level 3. Dr. Y of Mount Sinai responds directly to the patient on the special web site link arranged for such consultations, and gives patient Charles a series of questions regarding his past diagnosis and treatment, including the recommendations made by his current urologist for surgery and irradiation. Dr. Y summarizes the experience in this cancer type and stage for the patient, and advises him that his current doctor is following the best course of action, but also that there is a 40% chance that the benefit derived will only be temporary, and that later therapy may still be required. Patient Charles now feels more confident that he is making the right choice, and proceeds with the therapy recommended by his own urologist.

### EXAMPLE 4

### Level 4 Medical Monitoring Service

Patient Charles is six months post surgical and radiation therapy and is feeling fine, but has some pain upon urination and needs to monitor his urine for blood and the release of a tumor marker, which may be early signs of tumor recurrence. Since the original therapy, Patient Charles has also had a minor stroke, and is now partially paralyzed, thus being only partially ambulatory. Because it is difficult for him to return to his urologist or family practitioner weekly for a urinalysis, he decides to buy a home testing kit. The kit provides an analyzer using a probe placed into his urine sample, and a connection to a sensing and integration device. The sensing and integration device measures certain urine components (e.g., blood, protein) and transmits these results, via a hookup to his home computer, over the Internet to his practicing urologist. The urologist monitors these results weekly, and advises the patient that there are no changes of concern.

### EXAMPLE 5

### Level 4 Medical Therapy Intervention Service

Patient Charles is now two years post therapy of his bladder carcinoma, and is now under therapy for diabetes, requiring small quantities of insulin on a regular basis. In order to measure his blood glucose content regularly, he purchases a home measurement device. The home measurement device estimates the blood glucose level using a spectral analysis of the blood in the patient's finger and communicates the result through the Internet to the patient's family practitioner. The patient contacts his practitioner and is given instructions on how much insulin to inject himself with on a twice-weekly injection schedule. The system also provides this information to the patient directly, but the patient relies only on the physician's advice. Once per month, for example, he also performs an analysis at home of a small finger-derived drop of blood, placed into a miniature home glucose analyzer, which transmits the findings to his physician via his home Internet hookup. This testing provides quality-control for the finger spectral analysis being performed more frequently.

What is claimed is:

1. A multiple level service system comprising a processing device responsive to inquiries received over a communications medium, wherein the processing device identifies a level of service and provides a user progressively greater degrees of interaction at respective levels of service.

2. A system as recited in claim 1, the processing device being responsive to the inquiry by gathering, retrieving, and transmitting information at a first level of service.

3. A system as recited in claim 2, the processing device being responsive to the inquiry by distinguishing between a need for additional information and for referral to a professional to provide a response to the inquiry.

4. A system as recited in claim 3, the processing device being responsive to the inquiry by identifying and requesting additional information from a source of the inquiry if needed before referral to the professional.

5. A system as recited in claim 4, the processing device issuing commands to establish a communications link between the source of the inquiry and a communication device of the professional.

6. A system as recited in claim 5, the processing device being responsive to a further inquiry from one of the user and the professional to identify at least one other professional as a member of a referral team and to establish a link to the other professional.

7. A system as recited in claim 1, wherein the processing device receives image data from a remote site, thereby allowing remote observation of a patient's condition.

8. A system as recited in claim 1, wherein a health care professional is linked to the system to communicate with clients of the system, and evaluate information and diagnostic and other medical findings transmitted by the client into the system.

9. A system as recited in claim 2, wherein the information includes a list of research studies being conducted on an issue of interest.

10. A system as recited in claim 3, the processing device being programmed to monitor selected parameters associated with a user and to communicate messages to a device at the user's location that reads the parameters.

11. A system as recited in claim 10, the processing device being programmed to cause the device at the user's location to administer treatment to the user.

12. A system as recited in claim 3, the processing device being programmed to monitor selected parameters associated with a user and to communicate messages to a device which is remote from the user's location, wherein the processing device causes the remote device to administer treatment to the user.

13. A system as recited in claim 5, the processing device establishing a weighing function to weigh responses of the user and using the weighed responses to select the professional for referral.

14. A networked system linking individuals with a server that provides practical medical, veterinary, or health care information on disease or health subjects of interest to an inquirer, and allows the inquirer to interact with health care professionals at several levels, from pure information gathering to medical diagnostic and therapeutic interventions by telemedicine methods.

15. A system as recited in claim 14, wherein a client requests specific disease management information and options, and receives the information on a specific subject or question basis, the information being related to practice guidelines relevant to the inquirer's geographic region.

16. A system as recited in claim 14, wherein a client requests consultative services from a health care professional expert in an area of interest to the client.

17. A system as recited in claim 14, wherein a client receives consultative services from a health care professional expert in an area of interest to the inquirer.

18. A system as recited in claim 14, wherein a client receives a requested list of expert practitioners in his/her domicile or geographic region.

19. A system as recited in claim 14, wherein a client receives a requested list of ongoing clinical research trials pertaining to the management of a specific disease and state of interest to the client.

20. A system as recited in claim 14, wherein a client transmits telemedicine diagnostic findings or results via a network to a health care professional for improved patient or disease management.

21. A system as recited in claim 14, wherein a client can have therapeutic interventions performed via cyberspace telemedicine signals over the network.

22. A system as recited in claim 14, wherein a client can have therapeutic interventions performed utilizing images transmitted over the network.

23. A system as recited in claim 14, wherein the telemedicine signals can effect release of a chemical or drug into the client using an implanted device.

24. A system as recited in claim 20, wherein a client can have therapeutic interventions performed via cyberspace telemedicine signals over the network and wherein the telemedicine signals can effect release of a chemical or drug into the client by means of an implanted device.

25. A system as recited in claim 20, wherein a telemedicine diagnostic device is either in a home or at a facility, providing diagnostic findings to a second server for interpretation and recording.

26. A system as recited in claim 25, wherein the telemedicine diagnostic device comprises an imaging device which provides image data to the second server.

27. A system as recited in claim 25, wherein the diagnostic device is capable of analyzing at least one of anatomy, body functions, and body fluids, for certain disease markers or normal body components or functions, whereby the results can be transmitted to the second server on the network.

28. A networked health care service that provides a client with one or more levels of service.

29. A server for an electronic inquiry-based information system, intended for use with a computer connected to the server over a network, the server comprising:
a network connection to connect to the network and to provide a communication path with the computer;
a user interface to present information over the network to a user at the home computer, and to accept an inquiry over the network from the user at the home computer;
a system for determining a level of service access for the user;
a system for determining a level of sophistication of the user;
a search processor to create search requests used to acquire information requested in the user inquiry;
a system for providing a selection of professionals to the user and for creating a team from the selection of professionals for treating a health-related issue of the user; and
a communication system for directing the user inquiry to the team of professionals.

30. A method of providing practical medical, veterinary, or other health care information on disease or health subjects of interest to a user, the method comprising:
determining a desired level of service access for the user;
accepting an inquiry from the user;
composing a search request based on the user inquiry;
searching a database, using the search request, in order to identify information requested in the user inquiry;
providing the search results to the user;
accepting a follow-up inquiry from the user which entails providing a higher level of service access; and
allowing the user to request a consultation with a health care professional and, if desired by the user, providing the user with a list of possible health care professionals.

31. A method as recited in claim 30, further comprising:
accepting preferences, from the user, regarding health care professionals;
creating a weighing function to rank order health care professionals;
accepting a selection, from the user, of a health care professional; and
providing contact information, to the user, for the selected health care professional.

32. A method as recited in claim 30, further comprising transmitting telemedicine signals over a network to effect the release of a chemical or drug into the user through an implanted device.

33. A health care system for delivering health care to a patient, the system comprising:
a server, communicatively coupled to a network, for receiving and transmitting signals;
a monitoring device, communicatively coupled to the network and adapted to be connected to the patient, which is adapted to monitor the patient and to transmit patient information to the server over the network; and
a treatment device, communicatively coupled to the network and adapted to be connected to the patient, which receives a treatment signal from the server over the network and is adapted to administer a treatment to the patient based on the treatment signal received.

34. A health care system as recited in claim 33, wherein the treatment comprises a diagnostic procedure and the treatment device comprises a diagnostic device.

35. A health care system as recited in claim 33, further comprising a second treatment device, communicatively coupled to the server and remote from the patient, which receives the patient information from the monitoring device, analyzes the patient information, and transmits a treatment signal to the treatment device based on the patient information.

36. A health care system as recited in claim 33, wherein the treatment signal results in a treatment selected from a group consisting of an electrical impulse, a chemical stimulus, and a measured release of substance contained in a controlled-release reservoir implanted in a body of a patient and whose release is controlled by an implanted computerized chip.
